(19) United States
(12) Patent Application Publication
(10) Pub. No.: US 2004/0213431 A1
(43) Pub. Date: Oct. 28, 2004

(54) Electromagnetic audio transducer and or audio speaker

(76) Inventor: William Bernard Mello, Palacios, TX (US)

Correspondence Address: William Bernard Mello, P.O. Box 98, TALENT, OR, 97540, US

(21) Appl. No.: 10/372,513

(22) Filed: Apr. 25, 2003

(51) Int. Cl. H04R 1/00; H04R 9/06; H04R 11/02

(52) U.S. Cl. 381/430; 381/398

(57) ABSTRACT

Presenting a new Audio Transducer Profile Design and the placement of its components. The speaker cone placement to the voice coil rim and the suspention design connecting the cone assembly to the magnet and frame bar assembly design.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING A TABLE, OR A COMPUTER PROGRAM LISTING COMPACT DISC. APPENDIX

NOT APPLICABLE

### BACKGROUND OF INVENTION

Field of endeavor pertaining to audio transducers or audio speakers.

Classification definition suspected the same.

Relating references NOT APPLICABLE

Invention drawn toward improving efficiency and sound quality.

### BRIEF SUMMARY OF THE INVENTION

An audio speaker configuration where its greatest advantages are its ability to deliver much greater loudness efficiency and having outstanding sound quality in precisely capturing the presence or realism of the actual audio signal, that no known conventional speaker could ever equal. This is achieved by having the voice coil on the outer perimeter of the speaker cone and having said cone affixed to the face or side of the voice coil ring rather than the edge as in conventional method. This is the area of the voice coil that produces much greater loudness and clarity of the signal without any coloration. Secondly the magnet pole pieces being made of laminate iron, rather than conventional solid plate, yielding greater efficiency in power and more importantly increasing the uniformity of the magnetic flux field aiding in reducing distortion in its interrelation with the voice coils flux field, also the pneumatic suspention design completely isolating the voice coil and speaker cone from all other components.

### BRIEF DESCRIPTION OF THE SEVERAL VIEWS OF THE DRAWINGS

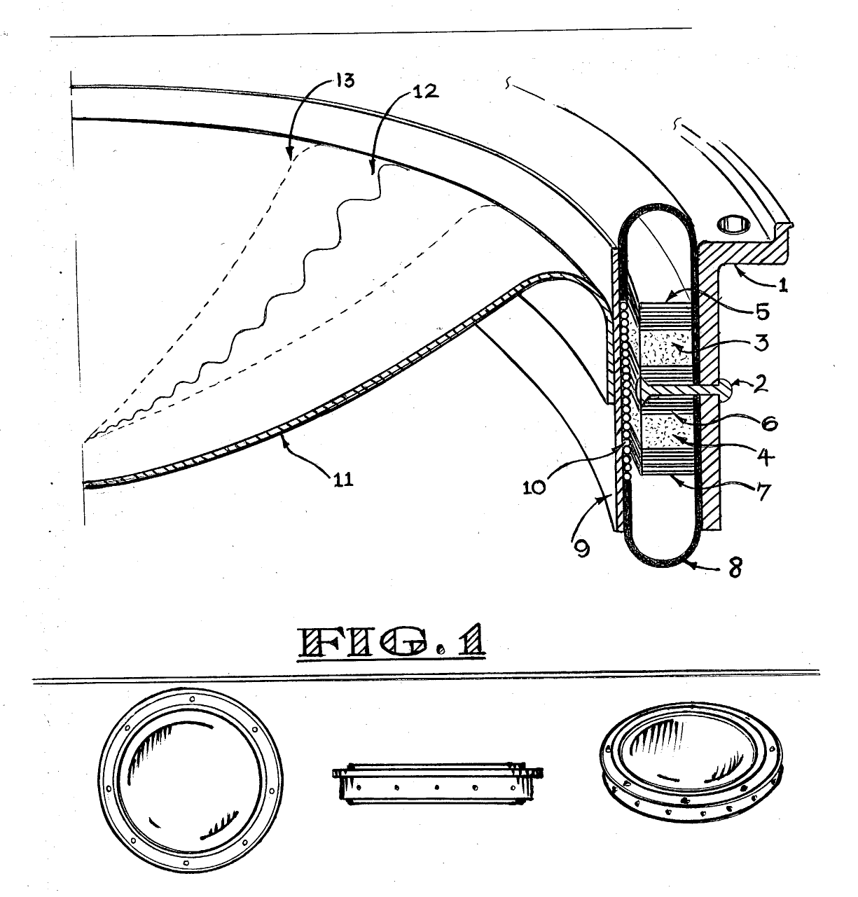

(Diagram FIG. 1) Indicates a half cross sectional view of the audio transducer assembly along with a quarter sectional view of a symmetrically round profile for the sake of easily visualizing the transducer design and maximizing the profile size for clear viewing, and upon viewing one can see the outstanding feature being the voice coil rim on the outside diameter of the speaker cone member. Drawings below (Diagram FIG. 1) shows the whole speaker profile as to see at a glance the distinguishable difference from conventional design.

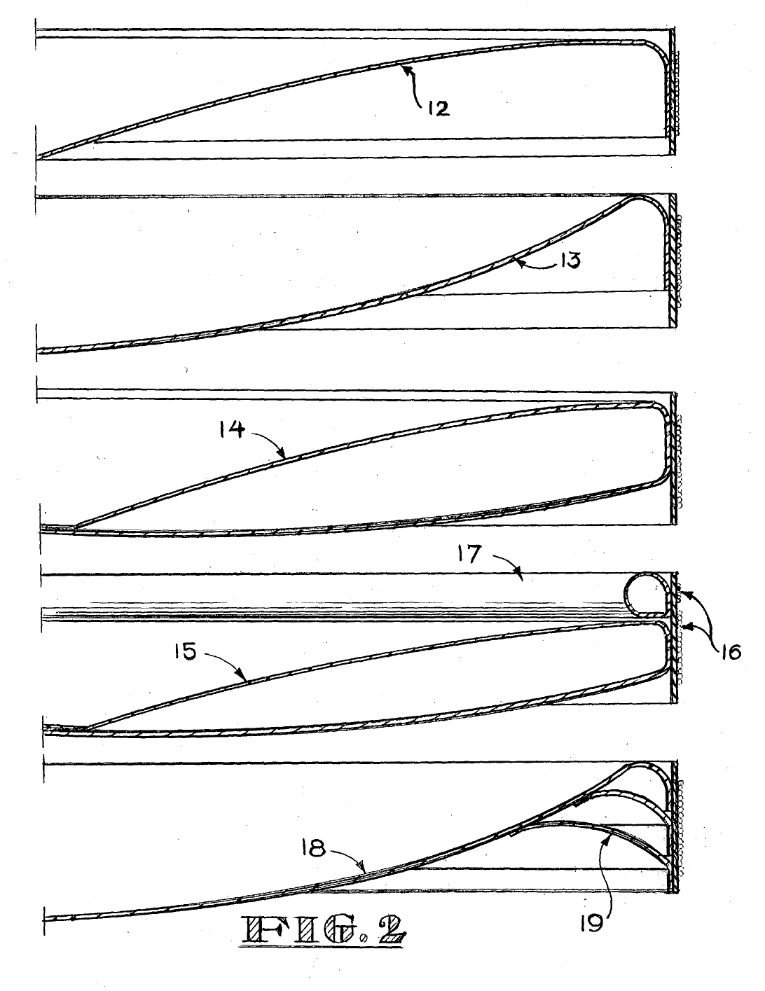

(Diagarm FIG. 2) Indicates five different speaker cone configurations and showing their placement on the voice coils rim bar.

### DETAILED DESCRIPTION OF THE INVENTION

Beginning with (Diagram FIG. 1 No. 1) Having a cylindrical or round outer mounting rim bar or ring known as a frame and having a flange at the top for bolting the assembly to a cabinet enclosure. Adhered to the inside diameter of the vertical section of the bar is a thin rubber or elastomer membrane No. 5 that encompasses the inside parameter as one piece and having upon it's width center a permanent magnet ring assembly No. 3, 4, 5, 6, and 7. Adhered and riveted No. 2 through the magnet, through the membrane No. 8 and through the mount rim No. 1 at intervals along its circumference as to firmly be affixed. Adhered to the pole ends of two magnet rings No. 3 and No. 4 are pole pieces of iron laminate rings No. 5, No. 6 and No. 7 that are stacked to a designated thickness to where the magnets flux field area is fully saturated by the iron laminates. Each pole end having both assemblies adhered together as one magnet, shown in (Diagram FIG. 1.) Unlike conventional method where solid iron plates are used. The laminat configuration gives greater efficiency in magnetic strength and more importantly greater uniformity in the magnetic flux field. Thus acquiring greater accuracy in the relation between the voice coil flux field and the magnets. That is the magnets flux field can cause distortions in the audio signal in the voice coils flux field. Having two magnets as described with iron pole pieces in the center furthers these advantages. Now having the membrane No. 8 looped around at each end being top and bottom adjacent and parallel to the magnet assembly and adhered to the outside perimeter of the electromagnetic voice coil rim bar ends No. 9 and places between these ends the electromagnetic wire voice coil No. 10 that is continuously wound around said parameter of the voice coil rim No. 9 where upon the two leads would protrude for connecting to the audio amplifier output terminals. Adhered to the inside diameter of the voice coil rim bar No. 9 is the basic speaker cone No. 11 that transduces the electromagnetic resonance induced by the voice coil to become a vibrating member to generate air waves duplicating the resonances. The adherence of said speaker cone No. 11 to the side wall of the voice coil bar No. 9 being a unique and critical factor in its design performance characteristics by its ability to transmit much greater resonance level with greater clarity and definition to the speaker cone member. Unlike conventional method where the resonance is picked up from one edge of the voice coil ring where the signal is muted and has coloration characteristics.

Upon the interior space of the enveloped rubber membrane tube No. 8 is pressurized with air giving the voice coil and cone assembly a full suspension of support to freely move as is the characteristics of audio speakers and also isolates vibration to the outer mount assembly thus eliminating any false coloring of the sound through relay. Also another beneficial factor is the air pressure applies a compressive force upon the voice coil rim No. 9 and thus applying a compressive force upon the speaker cone No. 11 designed with a specific force as to stress load the cone in a bending moment to the materials flexural yield point. This tensioning effect gives it a stabilizing characteristic where upon giving it the ability to reproduce the resonances sent through it with greater accuracy. Making it inapt to add false resonances from harmonic overlays as is with the relaxed or untentioned material state where even formed structural ribbing is not nearly as effective of preventing these distortions that occur.

In (Diagram FIG. 1) No. 12 indicates with a wave pattern line the vibration level showing the decay in level as it moves towards the center of the speaker cone to be advantageous in that the cone area or mass decreases. Indicated with diverging dotted lines No. 13. This proportionalizes with the signal decay giving a truer reproduction of the signal time. Unlike conventional method of projecting the signal from the center of the speaker cone where the decay factor enters larger area towards the outer rim causing a premature decay in the signal by having to move greater mass as the signal weakens thus falsifying the signals actual decay time.

In (Diagram FIG. 2) indicates several speaker cone configurations. In No. 12 indicates a simple convex profile. No. 13 indicates a simple concave profile No. 14 indicates the combination affixed to the voice coil ring bar and affixed at the joining centers. Combining two cones can offer two different material compositions and or thicknesses to arrive at capturing greater frequency response range. The lower cone that is behind the other would be heard as well do to cone materials being very acoustically transparent. Both surfaces act as one whole speaker cone. No. 16 indicates the use of dual voice coil windings. The upper wound for high frequency response and being transmitted through small looped speaker member No. 17 that circumferenciats the perimeter of the primary cones No. 15 to capture the full audio range in one speaker with the desired flat response profile of a audio signal graf In No. 18 indicates a concave primary cone having one or two ring like members No. 19 affixed to the voice coil ring bar and bridging across and affixed to the primary cone. This is for capturing more resonance from the voice coil as well as acquiring greater frequency response range.

This concludes my explanation indicating all of its design features and characteristics of a uniquely unified format of all its components that 1 believe redefines the audio transducer and how music will be heard.

What I claim as my invention is an ELECTROMAGNETIC AUDIO TRANSDUCER OR AUDIO SPEAKER,

1. THE VOICE COIL BEING ON THE OUTER PERIMETER OF THE SPEAKER CONE.

2. THE FACE AREA OR SIDE OF THE VOICE COIL RIM BAR OR RING, BEING THE AREA FOR THE PLACEMENT OF THE SPEAKER CONE.

3. PNUMATIC SUSPENTION OF THE PSSEAKER CONE AND VOICE COIL ASSEMBLY.

4. IRON LAMINATE POLE PIECES FOR THE MAGNETS.

5. THE VOICE COIL AND MAGNET ASSEMBLY PLACEMENT TO THE MOUNTING RIM BODY.

6. THREE DIFFERENT SPEAKER CONES EACH MADE UP OF MULTIPLE CONE ELEMENTS ASSEMBLED AS ONE UNIFIED MEMBER.
